(19) United States
(12) Patent Application Publication
(10) Pub. No.: US 2005/0213424 A1
(43) Pub. Date: Sep. 29, 2005

(54) Mixing apparatus

(76) Inventor: Ken Peterhans, Huntley, IL (US)

Correspondence Address: MERCHANT & GOULD PC, P.O. BOX 2903, MINNEAPOLIS, MN, 55402-0903, US

(21) Appl. No.: 10/976,359

(22) Filed: Oct. 26, 2004

Related U.S. Application Data
(60) Provisional application No. 60/515,004, filed on Oct. 27, 2003.

(51) Int. Cl. B01F 15/02

(52) U.S. Cl. 366/129; 366/150.1; 366/182.1

(57) ABSTRACT

A mixing apparatus including a mixing cart and a mounting arrangement. The mixing cart includes a base, wheels attached to the base, and handles. The mounting arrangement is configured to mount a bucket in a fixed position relative to the mixing cart. The mixing apparatus also includes a hopper for selectively dispensing material into a mounted bucket, a holder configured to hold a hand-held mixing device, and an extension piece coupled to the base that can be used as a standing platform.

### CROSS REFERENCE TO RELATED APPLICATION

This application claims the benefit of U.S. Provisional Patent Application Ser. No. 60/515,004, filed Oct. 27, 2003, which application is hereby incorporated by reference in its entirety.

### TECHNICAL FIELD

The principles disclosed relate to the operation and use of a mixing device. More particularly, this disclosure relates to a cart for use during operation of a mixing device.

### BACKGROUND

Typical methods for mixing materials for use in the construction industry, for example, involve labor-intensive steps. To illustrate, in projects involving the mixing of sand into epoxy and or additives into paint, people often use a drill and auger type mixing device to mix the materials in a bucket. Because of the low viscosity of some material, a second person is typically required to hold the bucket to prevent the bucket from spinning or tipping. Others may simply try to prevent the bucket from spinning or tipping by positioning and bracing the bucket between one's feet.

In general, improvement has been sought with respect to mixing methods and devices, generally to accommodate ease of use and increase efficiency and productivity.

### SUMMARY

In one aspect, the present disclosure relates to a mixing apparatus including a transportable cart having a base. The mixing apparatus also includes a mounting arrangement configured to detachably mount a bucket and a hopper attached to the cart, the hopper being located such that material contained within the hopper can be selectively dispensed into a mounted bucket. The apparatus also includes a holder for holding a hand-held mixing device and a moveable extension piece interconnected to the base.

In another aspect, the present disclosure relates to a mixing apparatus including a cart having a base, at least one wheel attached to the base, and a handle. The apparatus also includes an adjustable mounting arrangement configured to detachably mount a mixing container in a fixed position relative to the cart; and a hopper attached to the cart, the hopper being located in relation to the base of the cart such that material contained within the hopper can be selectively dispensed into a mounted bucket.

In still another aspect, the present disclosure relates to a mixing apparatus including a cart having a base, at least one wheel attached to the base, and a handle. The apparatus also includes an adjustable mounting arrangement configured to detachably mount a mixing container in a fixed position relative to the cart; and a holder pivotally attached to the cart, the holder being configured to receive and hold a hand-held mixing device. The apparatus further includes a locking arrangement configured to lock the holder in an outwardly extended position relative to the cart.

In yet another aspect, the present disclosure relates to a mixing apparatus including a cart having a base, at least one wheel attached to the base, and a handle. The apparatus also includes an adjustable mounting arrangement configured to detachably mount a mixing container in a fixed position relative to the cart; and a extension piece pivotally mounted to the base of the cart, the extension piece being configured to selectively pivot between a lowered position, whereby the extension piece provides a standing platform area, and a second generally upright position for storage or transport.

A variety of examples of desirable product features or methods are set forth in part in the description that follows, and in part will be apparent from the description, or may be learned by practicing various aspects of the disclosure. The aspects of the disclosure may relate to individual features as well as combinations of features. It is to be understood that both the foregoing general description and the following detailed description are explanatory only, and are not restrictive of the claimed invention.

### BRIEF DESCRIPTION OF THE DRAWINGS

FIG. 1 is a left side elevational view of one embodiment of a mixing apparatus according to the principles of the present invention;

FIG. 2 is a right side elevational view of the mixing apparatus of FIG. 1;

FIG. 3 is a left side elevational view of the mixing apparatus of FIG. 1, shown with an extension piece being pivoted.

FIG. 4 is a left side elevation view of the mixing apparatus of FIG. 1 shown being transported.

FIG. 5 is a front perspective view of a mixing apparatus embodiment similar to the mixing apparatus embodiment of FIG. 1 shown with the extension piece fully pivoted upward;

FIG. 6 is a side perspective view of the mixing apparatus of FIG. 1, shown without a mixing container positioned on the apparatus;

FIG. 7 is a front perspective view of one embodiment of a hopper of the mixing apparatus, in accord with the principles disclosed;

FIG. 8 is an enlarge, partial, top plan view of a portion of a cross-support member of the mixing apparatus of FIG. 1;

FIG. 9 is a side perspective view of the hopper of FIG. 7;

FIG. 10 is a rear perspective view of the cart apparatus of FIG. 1;

FIG. 11 is a top plan view of one embodiment of a bracket positioned at the rear of the cart apparatus shown in FIG. 10, in accord with the principles disclosed;

FIG. 12 is a side elevational view of the bracket of FIG. 11; and

FIG. 13 is a partial rear perspective of the cart apparatus of FIG. 10, shown with one embodiment of a holder positioned in a storage position, in accord with the principles disclosed.

### DETAILED DESCRIPTION

With reference now to the various figures in which identical elements are numbered identically throughout, a description of various exemplary aspects of the present invention will now be provided.

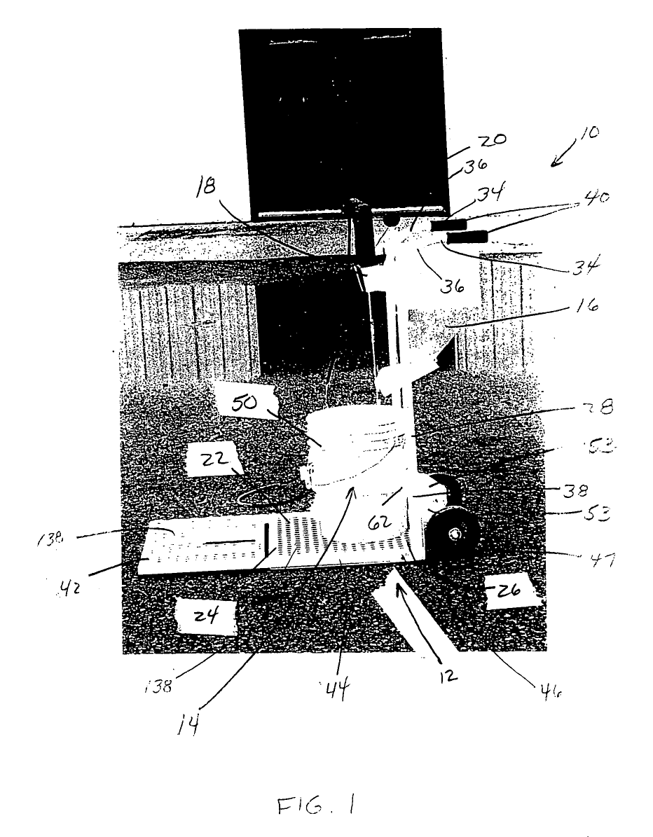

FIG. 1 illustrates a mixing apparatus 10 that is an embodiment of the present invention. In general, the mixing apparatus 10 includes a walk-behind structure, such as mixing cart 12 (i.e., a carriage or dolly) and a mounting arrangement or configuration 14 to detachably mount a mixing container 50. In the illustrated embodiment, the mixing apparatus 10 further includes a storage container or hopper 16 and a holder or hanger 18 for holding a mixing device 20.

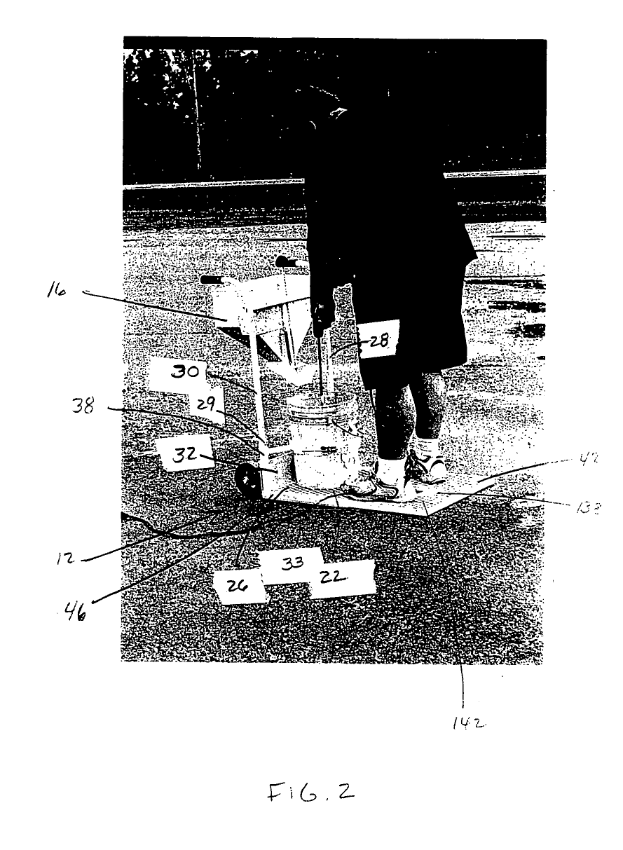

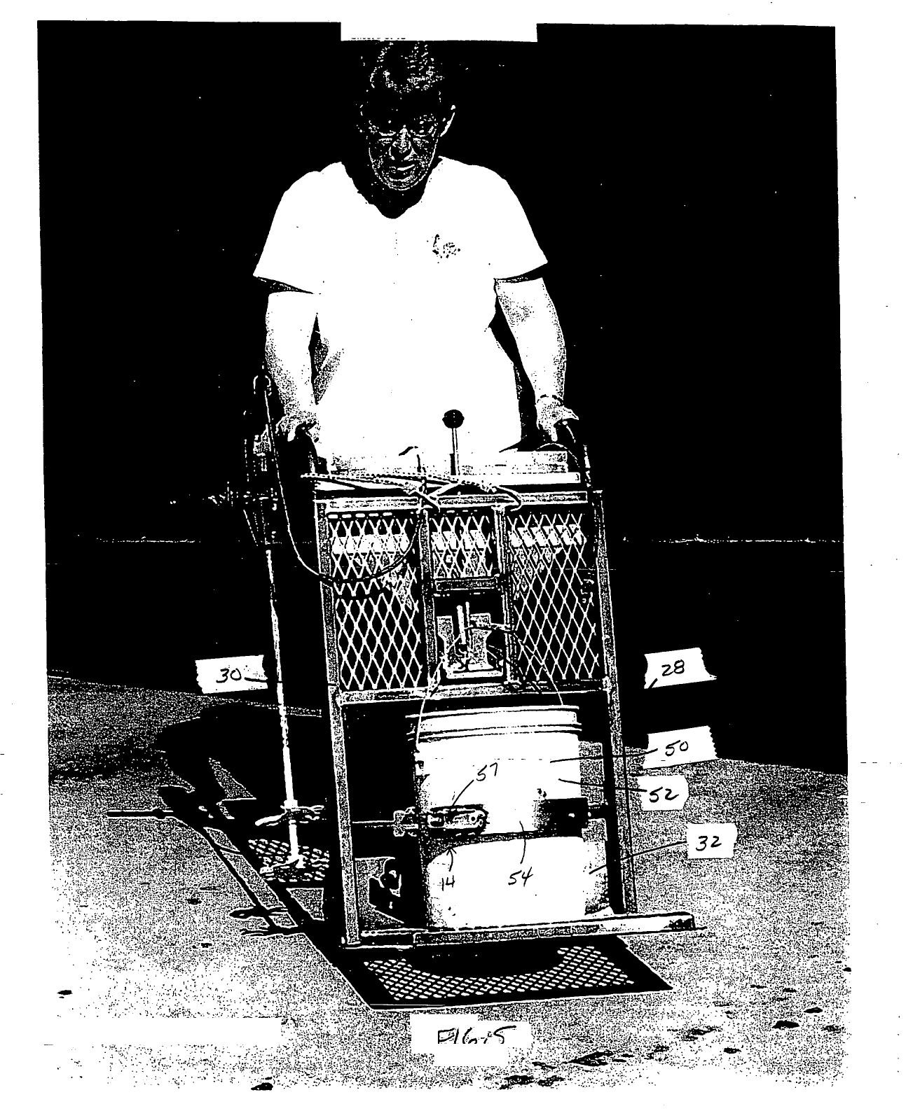

Referring now to FIGS. 1 and 2, the mixing cart 12 includes a main base 22 having a front end 24 and a rear end 26. Frame members 28, 30 are connected at opposite sides 31, 33 of the main base 22 adjacent to the rear end 26. The frame members 28, 30 are generally parallel to one another. The main base 22 is generally perpendicular to the frame members 28, 30. In one non-limiting embodiment, the frame members 28, 30 are constructed of tubular steel. A support structure 32 extends between frame members 28, 30 (see also FIG. 5).

Referring still to FIGS. 1 and 2, handles 34 are located at one end of the frame members 28, 30. The handles 34 extend outward from a bent or angled portion 36 of the frame members 28. 30. In the illustrated embodiment, grips 40 are placed on the handles 34. The height of each handle 34 may be adjusted by raising or lowering each of the frame members 28, 30. In particular, the frame members 28, 30 are positioned within tube supports 38 such that the frame members 28, 30 and handles 34 may be raised or lowered relative to the tube supports 38. In the illustrated embodiment, the tube supports 38 are welded or fastened to the main base 22 adjacent the rear end 26 of the main base 22. The frame members 28, 30 can be locked into a desired position relative to the tube supports 38 with fasteners 29 (such as set screws shown in FIG. 2). In some applications, the frame members 28, 30, handles 34, and hopper 16 may be removed altogether from the tube supports 38 in working locations where space is limited.

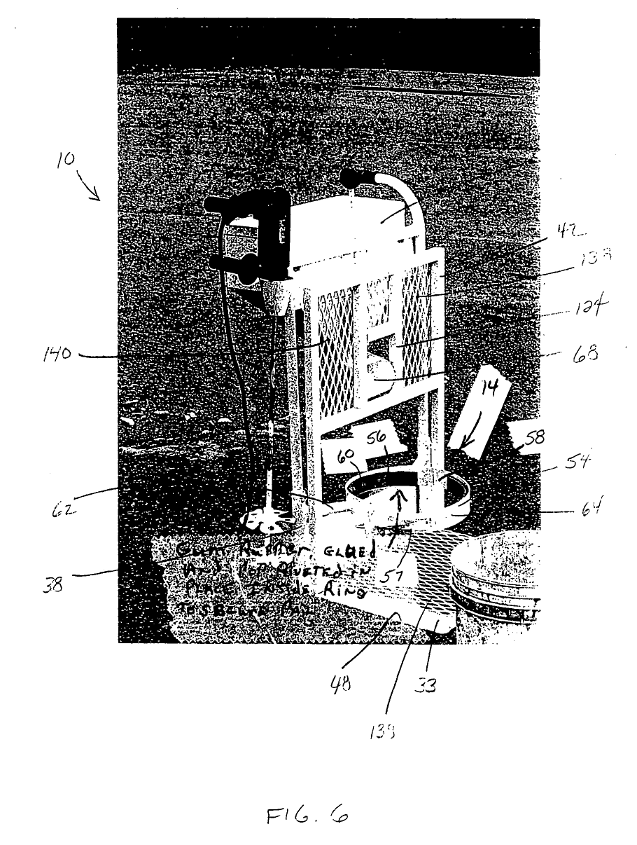

As shown in FIGS. 1-3, the mixing cart 12 includes an extension piece 42 interconnected the main base 22. The extension piece 42 includes arms 44 that are pivotally connected to the main base 22 adjacent the rear end 26 at pivot locations 46. When the extension piece 42 is pivoted to a first lowered position, as shown in FIG. 2, the arms 44 are positioned along the sides 31, 33 of the main base. In the illustrated embodiment, flanges 48 (FIG. 6) extend outward from the opposite sides 31, 33 of the main base 22 to support the extension piece 42.

As shown in FIGS. 1 and 2, the main base 22 and the extension piece 42 are made of a mesh or grate structure 138. The grate structure 138 includes diamond shaped openings 140 (FIG. 6) that permit spills and/or materials to fall through the grate structure 138. In use, typically a spill cloth or board, such as cardboard, is placed under the cart 12 to catch the spilled material. The grate structure 138 aids in maintaining the cleanliness of the cart 12 by permitting the spilled material to fall through to the cardboard. In addition, people in the construction industry often wear metal spiked shoes. If the main base 22 and extension piece 42 were to be made of solid sheet material, the spike shoes could cause a person to slip and fall. The grate structure 138 provides a person with a sure-footing surface to stand upon. In addition, the grate structure 138 raises the person up from the ground or floor so that the spikes of a person's shoes do not puncture the drop cloth or cardboard.

In addition, as shown in FIG. 2, the extension piece 42 is used as a standing platform 142 during mixing operations. By standing on the platform 142, a person's weight aids in preventing the mounting apparatus 10 from rotating when mixing very low viscous materials.

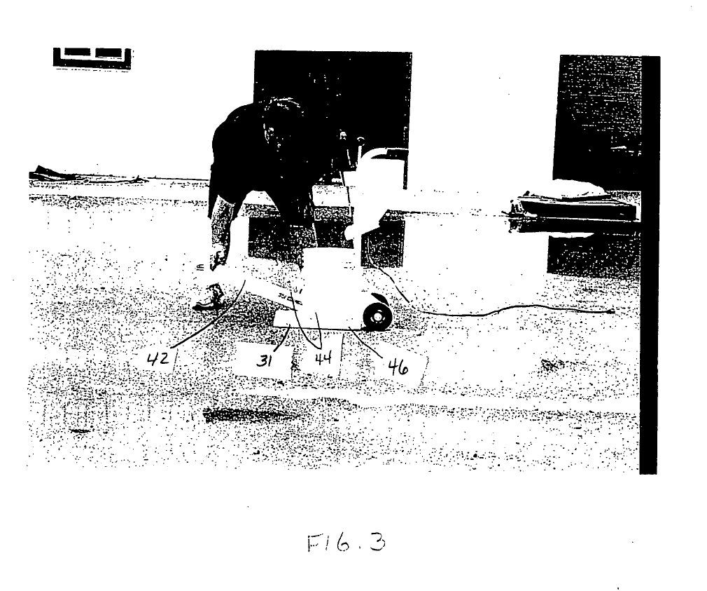

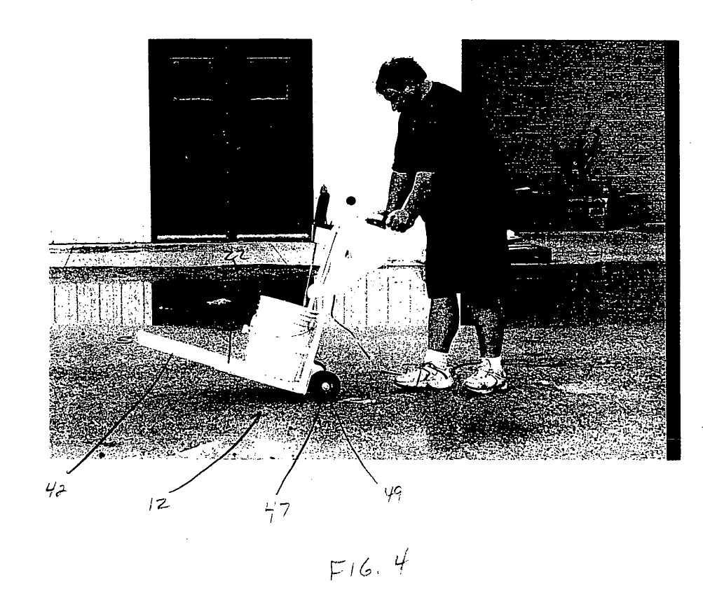

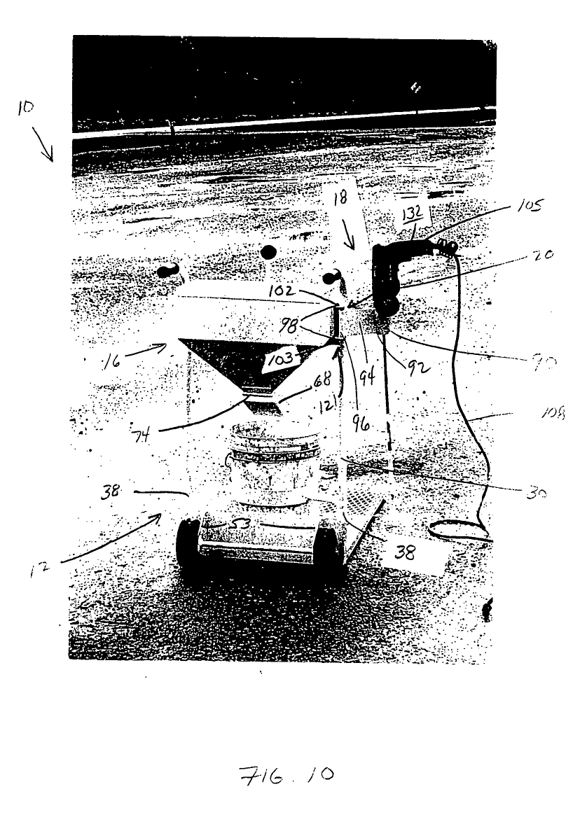

As will be discussed in greater detail hereinafter, the extension piece 42 is configured to pivot from the first lowered position to a second generally upright position, shown in FIGS. 3 and 6, for transport or storage of the mixing cart 12. As shown in FIG. 4, alternatively, the cart 12 can be transported or stored with the extension piece 42 in the lowered position. For transport, the mixing cart 12 has wheels 47 mounted on an axle 49. The axle 49 extends through holes 51 formed in wheel-mounting brackets 53 (FIGS. 1 and 10). The wheel-mounting brackets 53 are connected to the tube support 38.

Referring now to FIGS. 5 and 6, the mounting configuration 14 of the mixing apparatus 10 is configured to securely hold or retain a mixing container 50. In the illustrated embodiment, the mounting configuration 14 is configured to detachably mount a pail or bucket 52 positioned on the base 22 of the cart 12. In particular, the mounting configuration 14 includes a ring or collar clamp 54 that engages the outer diameter of the bucket 52. The bucket 52 may include a five-gallon bucket having a handle as shown, or other sized and configured buckets. Preferably, the collar clamp 54 is adjustable to accommodate a variety of sized and configured buckets.

In one embodiment, the collar clamp 54 is a split collar and includes an adjustable latch 57 that adjusts to the size of the mixing container 50. Gripping material 56 can be positioned on an inner surface 58 of the collar clamp 54. The gripping material 56 contacts the mixing container 50 to assist in preventing the mixing container 50 from spinning or rotating relative to the collar clamp 54. In the illustrated embodiment, the gripping material is a gum rubber strip 60 glued and/or fastened to the inner surface 58 of the collar clamp 54.

Referring to FIGS. 1 and 6, securing members 62 are welded or fastened to an outer surface 64 of the collar clamp 54 and the mixing cart 12 (i.e. the tube supports 38 of the mixing cart 12). The securing members 62 hold the collar clamp 54, and the mixing container 50, in a fixed position relative to the cart 12.

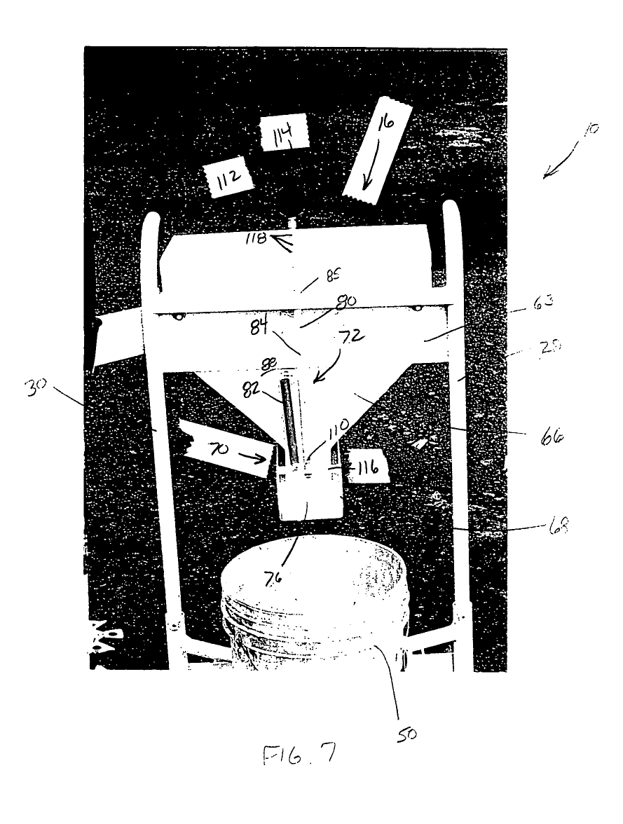

Referring now to FIG. 7, the hopper 16 is attached to a cross-support member 63. The cross-support member 63 is attached to frame members 28, 30 of the mixing cart 12. The hopper 16 is positioned to be above a mixing container 50 mounted to the cart 12. The hopper 16 generally includes a funnel shaped enclosure 66 for containing, storing, and dispensing mixing materials. The hopper 16 also includes a dispenser 68 located at a bottom region 70 of the hopper 16. The dispenser 68 is arranged to dispense mixing material contained with the hopper into a mixing container 50 or bucket 52 positioned on the main base 22 of the mixing cart 12.

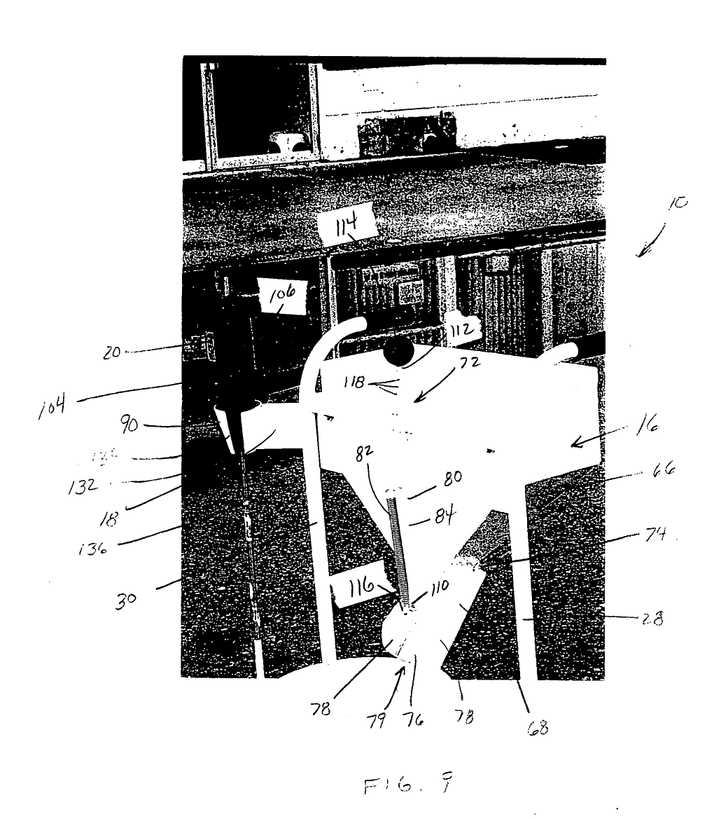

In particular, the dispenser 68 is attached to the funnel shaped enclosure 66 by a hinge 74 (FIG. 10). By this, a base portion 76 of the dispenser 68 is permitted to pivot relative to the hopper 16 to act as a door that opens and closes. When the dispenser is pivoted downward, the base portion 76 is oriented such that an opening (not shown) in the bottom region 70 of the hopper is exposed and mixing material is permitted to fall through the opening into the dispenser 68. Preferably, the dispenser 68 is designed with sides 78 (FIG. 9) that define a chute structure 79 to direct the flow of material into a mixing container 50.

Referring now to FIGS. 7-9, the hopper 16 also includes a dispensing mechanism 72 that biases the dispenser 68 to a normally closed orientation. The dispensing mechanism 72 includes an activation member 80 and a spring 82. The spring 82 biases the activation member 80 into the normally closed orientation. In the illustrated embodiment, the activation member 80 is a rod 84 having a first end 110 and a second end 112. The second end 112 of the rod 84 can include a handle piece 114 for maneuvering the rod 84. The first end 110 of the rod 84 is coupled to a cross piece 116 of the dispenser that extends between the sides 78 of the dispenser 68. The spring 82 is also secure to the cross piece 116 of the dispenser 68 and is secured to a side 88 of the hopper 16. The rod 84 is biased upward by the spring 82 in a direction to provide the normally closed orientation.

Other biasing arrangements can be used to preferably provide a normally closed dispensing arrangement in accord with the principles disclosed. For example, the dispenser mechanism can include a spring positioned about the rod 84 between the second end 90 of the rod 84 (e.g. the handle piece 114) and the cross-support member 63.

Referring still to FIGS. 7-9, the rod 84 is positioned through a hole 85 formed in the cross-support member 63 of the cart 12. In use, the rod 84 may be pushed downward within the hole 85, against the spring 82, to push the dispenser 68 downward and open the hopper 16. In the illustrated embodiment, the rod 84 may be locked into one of a plurality of dispensing positions. Each of the dispensing position corresponds to a particular dispensing flow rate. That is, each position provides an opening configuration and angular dispensing configuration so that a person may control the flow rate of material into a bucket 52.

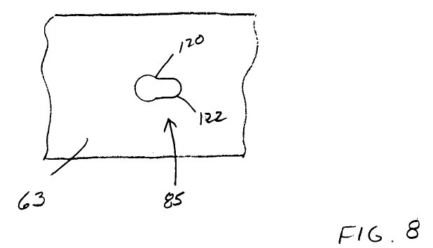

In particular, the rod 84 includes a plurality of notches 118 formed about the circumference of the rod 84; and hole 85 formed in the cross-support member 63 is a keyhole 120 (FIG. 8). In use, the rod 84 can be pushed downward to a desired dispensing position corresponding to a particular notch 118. The rod 84 can then be locked in the desired dispensing position by tilting the rod 84 sideways to engage the particular notch 118 with a reduced diameter portion 122 of the keyhole 120. This arrangement maintains the chute structure 79 of the dispenser in a particular angular orientation, and also can control the cross-sectional area of the opening (not shown) at the bottom region 70 the hopper 16. The notch and keyhole arrangement permits a person to lock the rod 84 into a selected dispensing position to control the flow rate of the mixing material.

Referring now to FIGS. 9 and 10, the mixing device holder 18 of the mixing apparatus 10 is attached to the mixing cart 12. The holder 18 is preferably pivotably mounted such that the holder 18, and the mixing device 20, can be pivoted outward from the side of the mixing cart 12 for easy access; and pivoted, for example, rearward for storage purposes.

The holder 18 is sized and configured to securely hold the mixing device 20. That is, the shape of the holder 18 is designed to securely retain the mixing device 20 while the holder is being pivoted and during transport of the cart 12. In the illustrated embodiment, the holder 18 includes a cone-shaped portion 90 configured to receive the nose of a mixing device 20 (e.g. a drill). The cone-shaped portion 90 has an opening 132 and a slot 134 to accommodate placement of, for example, a shaft 136 of the mixing device. Preferably, the slot 134 is located along the length of the cone-shaped portion 90 and oriented for access. That is, the slot 134 is preferably oriented such that when a person stands on the extension piece 42, the shaft 136 of the mixing device 20 easily slips through the slot 134 without having to maneuver the shaft 136 around the holder.

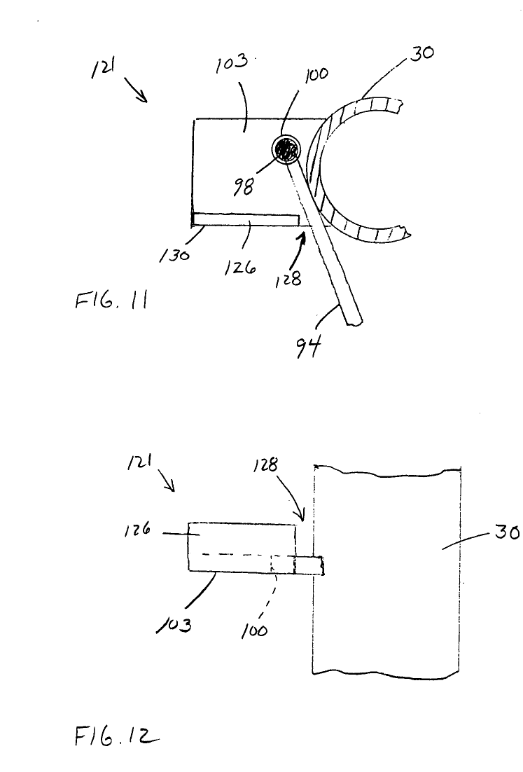

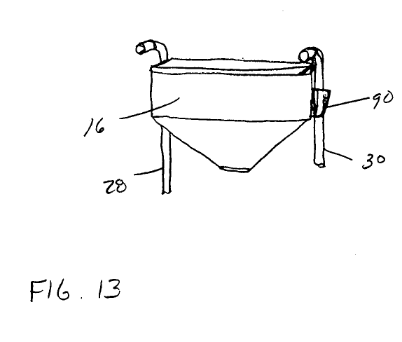

The cone-shaped portion 90 of the holder 18 is coupled to one end 92 of an arm 94. An opposite end 96 of the arm 94 is pivotably attached to the frame member 30 of the cart 12. In the illustrated embodiment, the opposite end 96 includes pin structures 98 positioned within holes 100 (FIGS. 11 and 12) formed in upper and lower brackets 102, 103 (hole 100 shown only in the lower bracket 103). The upper and lower brackets 102, 103 are welded or fastened to the frame member 30 of the cart 12. The pin structures 98 permit the arm 94 and thus the holder 18 to pivot between a storage position (FIG. 13, shown without a mixing device) and an outwardly extended position (FIG. 10).

The mixing apparatus 10 includes a locking arrangement 121 that locks the holder 18 in the outwardly extended position shown in FIG. 10. The locking arrangement 121 is defined by an upwardly bent flange or tab 126 extending along an outside edge 130 of the lower bracket 103 (FIGS. 11 and 12). As shown in FIG. 10, the upper and lower bracket 102, 103 are spaced apart to provide sufficient clearance gap 132 such that the arm 94 can be raised and lowered (in a direction coaxially aligned with the pins 98). To pivot and lock the holder 18 in the outwardly extended position, the holder 18 is raised and pivoted such that the arm 94 rides over the tab 124. The arm 94 then seats within a notched area 128 between the tab 124 and the frame member 30. When seated within the notched area 128, the arm 94 of the holder is locked between the tab 124 and the frame member 30. To return the holder 18 back to the storage position, the holder 18 or arm 94 is lifted to ride back over the tab 124 and is pivoted rearwardly. It is contemplated that a second tab or lock-type structure can be incorporated to lock the arm in the storage position also.

The mixing device 20 used in accord with the principles disclosed may include a variety of mixing devices known to those of skill in the art. The illustrated mixing device 20 is a hand-held drill/auger 104 (FIG. 10) having a handle 105, a power switch 106, and an electric power cord 108. What is meant by hand-held is that the device is capable of operating apart from and separate from the mixing cart 12. In one embodiment, the hand-held mixing device 20 illustrated is a hand-held drill shown with an interchangeable 30-inch auger bit. Other hand-held mixing devices configurations may be used in accordance with the principles herein disclosed. While it is preferred to use a hand-held mixing device, mixing devices may also be permanent mounted to the mixing cart 12.

In operation, the mixing apparatus 10 can be used by a single person to mix materials in a mixing container 50, such as a bucket 52, without strenuously trying to hold the bucket. Typically, the bucket contains a liquid material into which an amount of solid material is mixed. The solid material is typically contained and stored in the hopper 16. In some applications, the mixing apparatus 10 is used to mix sand into a bucket containing epoxy or to mix additives into a bucket containing paint. In other applications, the solid material may include cellulose, granite chips, concrete mixes, and other thickening agents, fillers and additives, in addition to sand and paint additives. Likewise, in other applications, the liquid material may include water, urethane, mortar and other liquid mediums in addition to the epoxy and paint.

In use, the hopper 16 is filled with a mixing material. The bucket 52 is set on the main base 22 of the cart 12. The collar clamp 54 is positioned about the bucket 52 and the adjustable latch 57 is latched to secure the bucket in a fixed position relative to the cart 12. The dispensing mechanism 72 may be used to dispense a desired amount of mixing material into the bucket 52. In particular, the rod 84 is pushed downward against the spring 82 to open the hopper 16. As the hopper opens, mixing material flows down the chute structure 79 of the dispenser 68. The rod 84 is released to close the hopper 16 when the desired amount of mixing material has been dispensed into the bucket 52. In some operations, it may be desirable to lock to rod 84 into one of a plurality of dispensing position to control the flow rate of the mixing material or to operate the mixing device 20 concurrently with dispensing the mixing material.

The mixing device 20 is used to mix the materials contained in the bucket 52. The mixing device holder 18 swings or pivots outward from the storage position to the outwardly extended position for easy access. The holder 18 locks into the outwardly extended position so that when a person attempts to place the mixing device 20 back into the holder 18, the holder does not swing or pivot out of position; rather the holder 18 remain securely positioned and retained within notched area 128 defined by the tab 124 of the lower bracket 103.

As shown in FIGS. 4 and 5, the mixing cart 12 can be used to transport mixing containers 50 also. For example, when mixing is complete, the cart 12 may be tipped or tilted backwards and rolled to a location for use. This is particularly convenience in work areas where epoxy or paint, for example, cannot be mixed in the work area for ventilation reasons, etc. With the presently disclose mixing apparatus, mixing can be done away from a work area and transported to the work area after the mixing is finished.

As can be understood, a number of mixing containers or buckets can be used with the presently disclosed mixing apparatus 10. That is, the mixing apparatus 10 does not require a single mixing container, rather can be used to increase productivity and efficiencies by mixing a second, third, fourth, etc. bucket of material, while a first mixed bucket is being concurrently used.

When not in used, the mixing apparatus 10 is configured to collapse or fold into a storage configuration that utilizes less space than the “in-use” configuration. In particular, the extension piece 42 pivots or folds up to reduce the overall length of the mixing cart 12. Referring to FIG. 6, the extension piece 42, includes a cut-out region 124 that provides clearance for the dispenser 68 of the hopper 16 when the extension piece 432 is pivoted upward to the storage configuration. Also, as shown in FIG. 13, the mixing device holder 18 can be pivoted rearwardly to reduce the overall width of the mixing cart 12.

The above specification provides a complete description of the MIXING CART. Since many embodiments of the invention can be made without departing from the spirit and scope of the invention, certain aspects of the invention reside in the claims hereinafter appended.

1. A mixing apparatus comprising:
a) a transportable cart having a base;
b) a mounting arrangement configured to detachably mount a bucket;
c) a hopper attached to the cart, the hopper being located such that material contained within the hopper can be selectively dispensed into a mounted bucket;
d) a holder for holding a hand-held mixing device; and
e) a moveable extension piece interconnected to the base.

2. The mixing apparatus of claim 1, wherein the cart includes handles and wheels for transport from one location to another location.

3. The mixing apparatus of claim 1, wherein the extension piece includes a standing platform area.

4. The mixing apparatus of claim 3, wherein the extension piece is pivotally mounted to the base, the extension piece being configured to selectively pivot between a lowered position, whereby the extension piece provides the standing platform area, and a second generally upright position for storage or transport.

5. The mixing apparatus of claim 4, wherein the extension piece includes a cut-out region to provide clearance for the hopper when the extension piece is selectively pivoted to the second generally upright position.

6. The mixing apparatus of claim 1, wherein base and the extension piece include a mesh surface to permit spilled materials to fall through openings of the mesh surface.

7. The mixing apparatus of claim 1, wherein the mounting arrangement includes an adjustable clamping device.

8. The mixing apparatus of claim 7, wherein the adjustable clamping device includes a collar clamp configured to clamp around the exterior surface of a bucket.

9. The mixing apparatus of claim 7, wherein the collar clamp includes gripping material to assist in maintaining a mounted bucket in a fixed position relative to the cart.

10. The mixing apparatus of claim 1, wherein the hopper includes a dispensing mechanism and a chute arrangement, the dispensing mechanism being interconnected to the chute arrangement for selectively dispensing material contained within the hopper into a mounted bucket.

11. The mixing apparatus of claim 10, wherein the dispensing arrangement includes an actuator and a spring, the spring being configured to bias the chute arrangement to a first position, the hopper being closed when the chute arrangement is biased to the first position.

12. The apparatus of claim 11, wherein the actuator is configured to selectively move the chute arrangement to one of a plurality of dispensing positions, and wherein the hopper opens to dispense material contained within the hopper when the chute arrangement is positioned in any one of the plurality of dispensing positions.

13. The apparatus of claim 11, wherein the actuator is a rod interconnected to the chute arrangement.

14. The apparatus of claim 10, wherein the dispensing mechanism and chute arrangement can be selectively locked in a plurality of dispensing positions, each of the dispensing positions corresponding to a particular flow rate at which material contained within the hopper is dispensed.

15. The mixing apparatus of claim 1, wherein the holder is pivotally connected to the cart and configured to pivot from a storage position to an outwardly extend position.

16. The mixing apparatus of claim 15, further including a locking arrangement wherein the holder can be releasably locked into the outwardly extend position.

17. The mixing apparatus of claim 1, wherein the bucket is a five-gallon bucket having a handle.

18. A mixing apparatus comprising:
a) a cart having a base, at least one wheel attached to the base, and a handle;
b) an adjustable mounting arrangement configured to detachably mount a mixing container in a fixed position relative to the cart; and
c) a hopper attached to the cart, the hopper being located in relation to the base of the cart such that material contained within the hopper can be selectively dispensed into a mounted bucket.

19. A mixing apparatus comprising:
a) a cart having a base, at least one wheel attached to the base, and a handle;
b) an adjustable mounting arrangement configured to detachably mount a mixing container in a fixed position relative to the cart;
c) a holder pivotally attached to the cart, the holder being configured to receive and hold a hand-held mixing device; and
d) a locking arrangement configured to lock the holder in an outwardly extended position relative to the cart.

20. A mixing apparatus comprising:
a) a cart having a base, at least one wheel attached to the base, and a handle;
b) an adjustable mounting arrangement configured to detachably mount a mixing container in a fixed position relative to the cart; and
c) a extension piece pivotally mounted to the base of the cart, the extension piece being configured to selectively pivot between a lowered position, whereby the extension piece provides a standing platform area, and a second generally upright position for storage or transport.
